(19) United States
(12) Patent Application Publication
(10) Pub. No.: US 2016/0292764 A1
(43) Pub. Date: Oct. 6, 2016

(54) SYSTEM AND METHOD FOR GENERATING A STORE DIRECTORY BASED ON A PERSONALIZED SHOPPING LIST

(71) Applicant: Feliks Kravets, Hawthorn Woods, IL (US)

(72) Inventor: Feliks Kravets, Hawthorn Woods, IL (US)

(21) Appl. No.: 14/678,979

(22) Filed: Apr. 4, 2015

(51) Int. Cl. G06Q 30/06

(52) U.S. Cl. CPC G06Q 30/0627; G06Q 30/0625; G06Q 30/0633; G06Q 30/0639; G06Q 30/0643

(57) ABSTRACT

A method comprising steps (a) a user at a geographical location using a mobile device logs in to a mobile computer network system; (b) the user generates a list of items; (c) the user enters a plurality of search preferences, wherein the plurality of search preferences consists of a percentage match filter value, a distance filter value, and a selection of optional special preferences filters; and (d) a first directory list is provided as a result of the plurality of search preferences, wherein the directory list comprises a first list of stores.

### CROSS-REFERENCE TO RELATED APPLICATIONS

N/A

### BACKGROUND OF THE INVENTION

1. Field of the Invention

The present invention is in the technical field of data processing. More particularly, the present invention relates to a system and method for generating a store directory based on a personalized shopping list.

2. Discussion of the State of the Art

Consumers have been generating shopping lists before the Internet existed. The process would include hand writing a list of grocery items that needed to be purchased in the future. There was no guarantee that all of the grocery items would be available when the consumers visited the grocery store. Further, there is a limited idea of the cost associated with the list of grocery items. Most consumers have a general idea which grocery store carries which items and the comparison cost of each grocery store, but nothing is certain. Additionally, consumers have preconceived notions about specific grocery store cost and item availability that are based on perception and opinions of other consumers.

Many consumers have dietary restrictions as well as dietary preferences, such as gluten free, kosher, halal, and organic foods. It is generally unknown if these specialty food items are available and in stock. Even if it is assumed that a particular store carries a specialty food item, without being certain, it would be an extremely time consuming to travel to that particular store only to find out that the item is not available.

The subject matter claimed attempts to solve these disadvantages while providing other useful features that improve a consumers shopping experience. The inventive embodiments described below give consumers total control of their shopping expectations, saving time and making their shopping experience more efficient.

### BRIEF SUMMARY OF THE INVENTION

In one embodiment of the present invention, a method is provided comprising steps (a) a user at a geographical location using a mobile device logs in to a mobile computer network system; (b) the user generates a list of items; (c) the user enters a plurality of search preferences, wherein the plurality of search preferences consists of a percentage match filter value, a distance filter value, and a selection of optional special preferences filters; and (d) a first directory list is provided as a result of the plurality of search preferences, wherein the directory list comprises a first list of stores.

In one embodiment, in step (b), the list of items is a shopping list comprising a plurality of edible items. In one embodiment, in step (b), the list of items is added to a previously saved list of items creating a new single list of items, the new single list of items is a shopping list comprising a plurality of edible items, the plurality of edible items can be added or deleted from the shopping list, wherein the user is limited to one shopping list. In one embodiment, in step (c), the percentage match filter value allows the user to set a minimum percentage match value such that: the first list of stores is limited to a filtered list of stores having an inventory list comprising a percentage value of items that are equal to the list of items generated by the user, wherein the percentage value of items is greater or equal to the minimum percentage match value.

Also in one embodiment, in step (c), the distance filter value allows the user to set a maximum distance value such that: the first list of stores is limited to a filtered list of stores having a proximity, wherein the proximity is at a distance that is less than or equal to that maximum distance value from the geographical location of the user. Still in one embodiment, in step (c), the selection of optional special preferences filters comprises a plurality of filters essentially consisting of a gluten free filter, a kosher filter, an organic filter, and a halal filter. Yet in another embodiment, in step (c), the selection of optional special preferences filters allows the user to select any filter in the plurality of filters such that: the first list of stores is limited to a filtered list of stores having an inventory list comprising a list of items that match any of the selected filters of the plurality of filters in the selection of optional special preferences filters.

In one embodiment, in step (d), the first list of stores is represented on a graphical map. Still in one embodiment, in step (d), each store included in the first list of stores comprises an inventory list. Also in one embodiment there is further a step wherein the plurality of search preferences can be modified, wherein the modifications correlate to a second directory list provided, the second directory list having a second list of stores. In one embodiment, the second list of stores is represented on a graphical map, and each store included in the second list of stores comprises an inventory list.

In another aspect of the invention, a system is provided comprising an Internet-connected computerized appliance having a processor and coupled to a data repository, the processor executing software from a non-transitory medium, the software providing an interactive interface to a mobile application system, the system enabling a user to create an account; log on and enter a location; create a shopping list of items; set a plurality of search preferences; set user preferences; access a directory list of local stores, each store having an inventory list of items; access an address and driving directions to each store; compare the shopping list to the inventory list of items; visualize the comparison of the shopping list of items to the inventory list of items as a percentage value defining the number of matching item in the shopping list of items to the inventory list of items; and define a minimum percentage value limiting the directory list of local stores to only stores with the percentage value greater or equal to the minimum percentage value.

In one embodiment, search preferences comprises a plurality of filters essentially consisting of a gluten free filter, a kosher filter, an organic filter, and a halal filter.

### BRIEF DESCRIPTION OF THE SEVERAL VIEWS OF THE DRAWINGS

FIG. 1 is an architectural diagram of an Internet mobile computer network system according to an embodiment of the present invention.

FIG. 2 is an architectural diagram of a mobile application software and web server according to an embodiment of the present invention.

FIG. 3 is a screenshot of a user interface illustrating a registration interface according to an embodiment of the present invention

FIG. 4 is a screenshot of a user interface illustrating an application menu according to an embodiment of the present invention.

FIG. 5 is a screenshot of a user interface illustrating a user preferences page according to an embodiment of the present invention.

FIGS. 6-9 are screenshots of a user interface illustrating a shopping list interface according to an embodiment of the present invention.

FIG. 10 is a screenshot of a user interface illustrating a plurality of search preferences according to an embodiment of the present invention.

FIG. 11 is a screenshot of a user interface illustrating a shopping list interface according to an embodiment of the present invention.

FIGS. 12-16 are screenshots of a user interface illustrating a directory interface according to an embodiment of the present invention.

FIG. 17 is a screenshot of a user interface illustrating a shopping list interface according to an embodiment of the present invention.

FIG. 18 is a block diagram illustrating the mobile application software of FIG. 1 according to an embodiment of the present invention.

FIG. 19 illustrates a flowchart for a mobile application according to an embodiment of the present invention.

FIG. 20 illustrates a flowchart for a mobile application according to an embodiment of the present invention.

FIG. 21 is an architectural diagram of an Internet mobile computer network system according to an embodiment of the present invention.

FIG. 22 is an architectural diagram of a mobile application software network system according to an embodiment of the present invention.

### DETAILED DESCRIPTION OF THE INVENTION

In one embodiment of the instant invention the inventor provides a system and method for generating a store directory based on a personalized shopping list that allows users total control of their shopping expectations while saving time and making their shopping experience more efficient. The system in a preferred embodiment dynamically manages a user shopping list and preferences that enables real time aggregation of search results represented by a directory of store listings corresponding to predefined conditions. The system and methods of the invention are described in detail below.

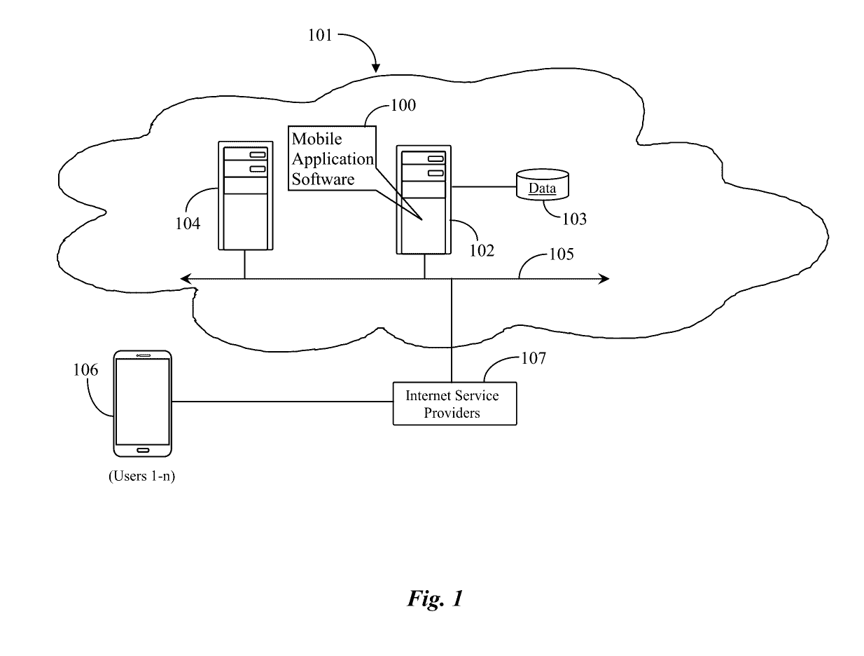

FIG. 1 is an architectural diagram of an Internet 101 mobile computer network system according to an embodiment of the present invention. The Internet-connected system comprises one or more Internet-connected servers 102 executing mobile application software 100 from non-transitory media. Server 102 is connected to a data repository 103, which may be any sort of data storage known in the art. The system further comprises a third party Internet-connected server 104 connected to Internet backbone 105. Although one third party Internet-connected server 104 is shown, it is understood that potentially millions of other similar servers are connected to the Internet via Internet backbone 105. A number of users (1-n) 106 on a mobile device are connected to the Internet-connected server via an Internet service provider (ISP) 107, allowing users 106 to access the mobile application software.

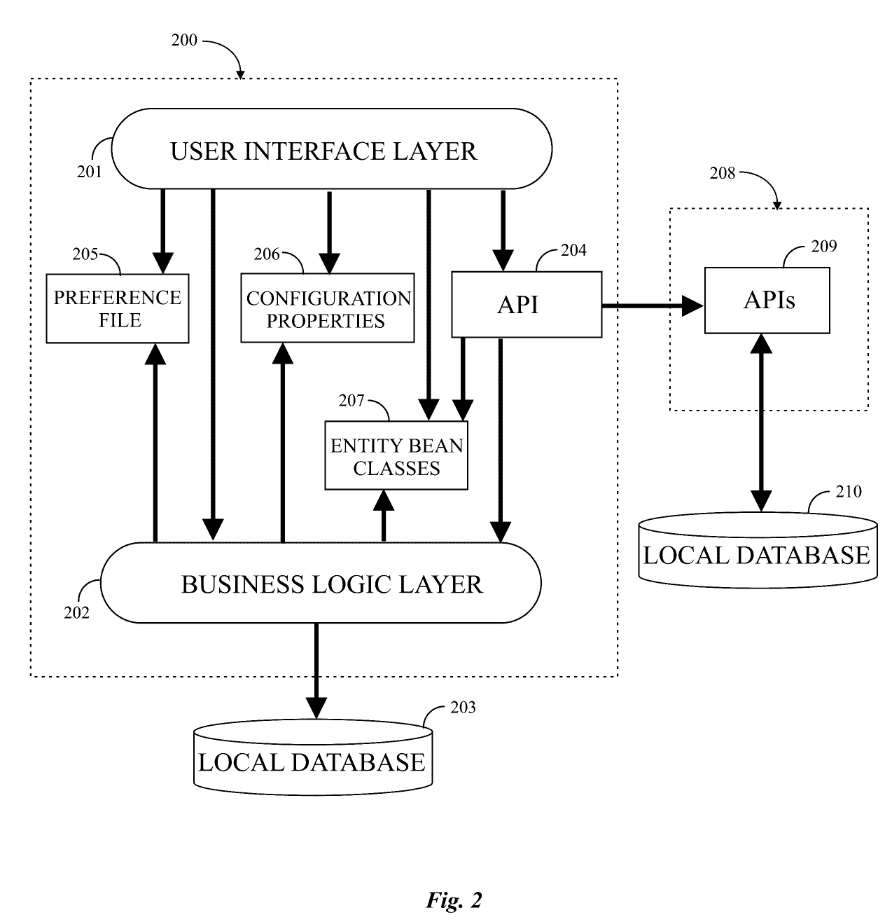

FIG. 2 is an architectural diagram of a mobile application software 200 and web server 208 according to an embodiment of the present invention. The mobile application comprises a user interface (UI) layer 201 and business logic layer 202. The user interface layer is the point at which user and machine interactions occur, such as activities and screens that a user may navigate. The business logic layer is the programming that manages communication between the user interface layer and a local database 203, representing a storage database on a mobile device. In communication with both layers is an application program interface (API) 205, a preference file 205, configuration properties 206, and entity bean classes 207 passing messages between layers as known in the art. The preference file maintains application status with stored parameters, and defined variables and behavior. The configuration properties are initial fixed elements and settings that are static. The application program interface specifies how the mobile application components should interact with the web server based on user inputs at the user interface layer and rules defined by the business logic layer. The application program interface calls external APIs 209 which is in communication with a local database 210, representing a data repository of the web server 208.

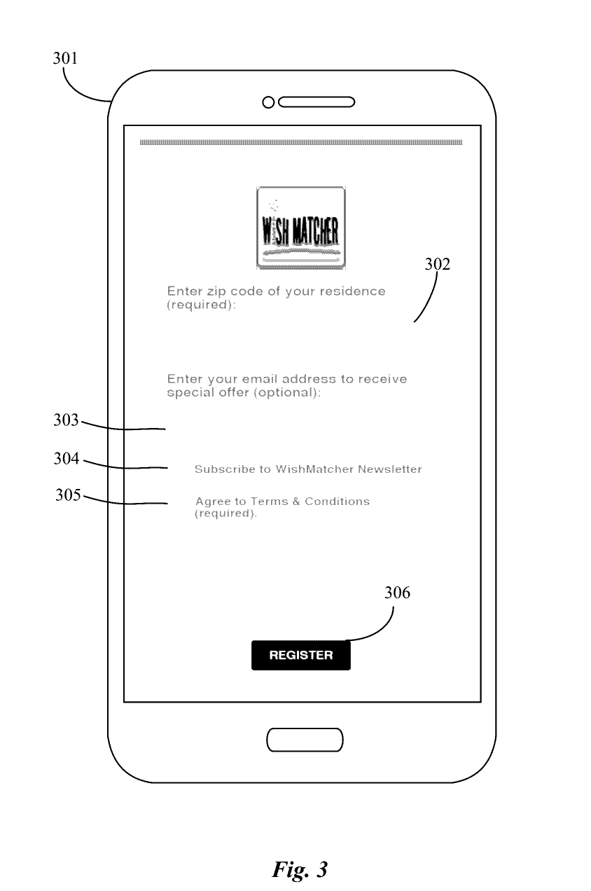

FIG. 3 is a screenshot of a user interface illustrating a registration interface according to an embodiment of the present invention. The user interface is shown on a mobile device 301. The mobile device may be a smartphone running an Android operating system or iOS, an operating system (OS) found on Apple, Inc. products such as an iPhone or iPad. The mobile device comprises a screen for displaying user interfaces, a processor, a storage device, a cellular network antenna for connection with cellular networks by communication with satellites, and Wi-Fi capabilities for connection with local Internet networks as well known in the art.

The registration interface allows a user to create an account which enables a user to set preferences, enter a location, and create a shopping list to be stored locally in the system. On the registration interface a user may enter a location query 302 which includes their ZIP code of their current location or residence location. The location query is required, and is used for marketing and census purposes. Next, the user is prompted with an optional query allowing the input of an email address 303. If entered, the user may receive special offers delivered to the email address provided. The user also has the option to select a graphical control element 304, which subscribes the user to a periodical newsletter, delivered to the email address provided. Finally, the user is required to a select a graphical control element to agree to a Terms & Conditions clause 305 including the terms of service, policies, and guidelines of using the mobile application software. The user may also enter a promo-code to providing the user discounts and deals as known in the art. Once all the selections and inputs are completed, the user may register 306 completing the registration process.

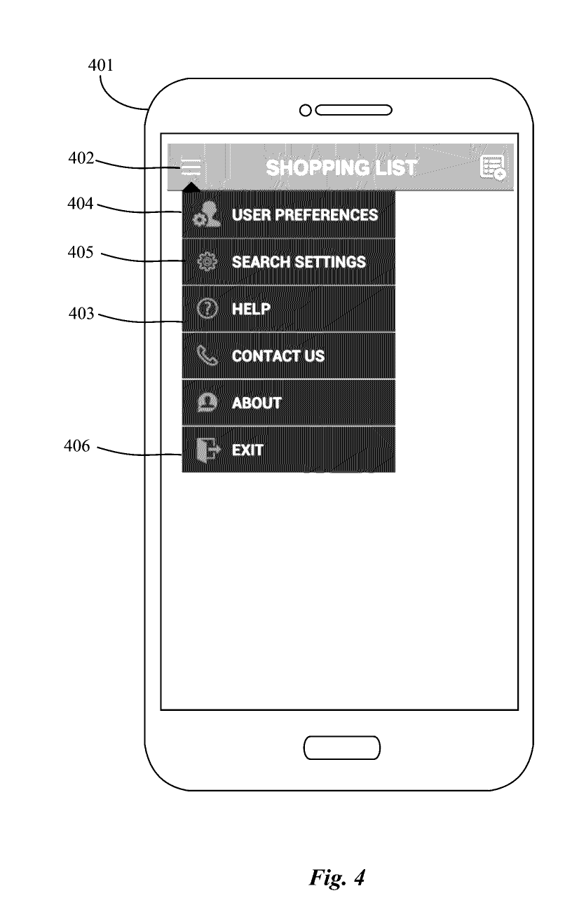

FIG. 4 is a screenshot of a user interface illustrating an application menu 403 according to an embodiment of the present invention. The user interface is shown on a mobile device 401. The application menu is prompted and expanded with the selection of menu icon 402. Application menu 403 includes menu navigational options including user preferences 404, search settings 405, help, contact us, about, and exit 406. The user preferences, search settings, and exit navigational options will be discussed in further detail below. The other navigational options including help, contact us, and about are known in the art and function as expected. The help option allows a user access for assistance in operating the mobile application. The contact us option allows a user to contact an administration person. The about option allows a user to read more information describing the mobile application and the company administering the mobile application.

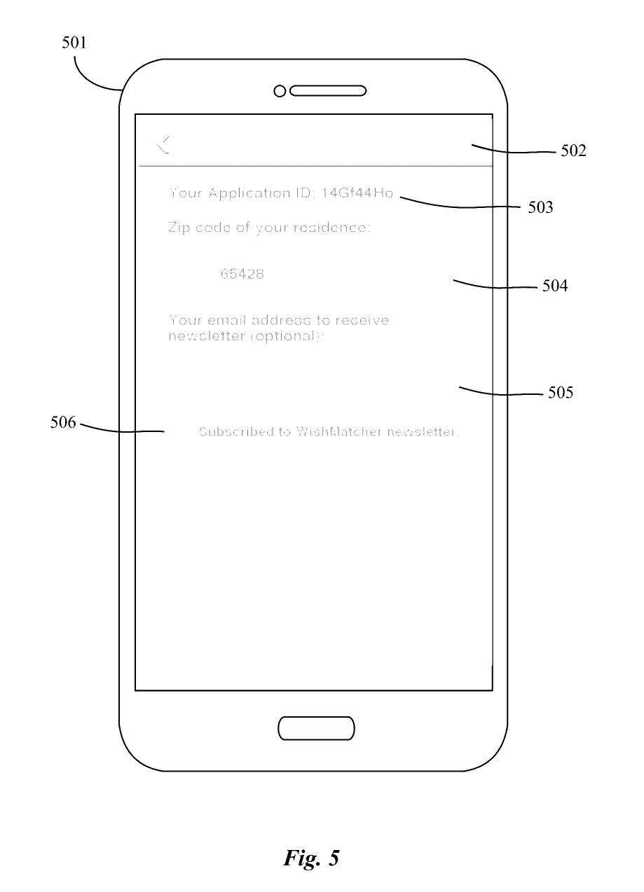

FIG. 5 is a screenshot of a user interface illustrating a user preferences page 502 according to an embodiment of the present invention. If a user selects the user preferences navigational option 404 (FIG. 4), the current user interface and user preferences page is shown on mobile device 501. The user preferences page displays the user's unique application identification (ID) 503, as well as the user's ZIP code of the location query 504, and the optional email address query 505. The user also has the option to select a graphical control element 506, which subscribes the user to a periodical newsletter, delivered to the email address provided. The user may change any of the above information, or choose to enter information that was previously omitted.

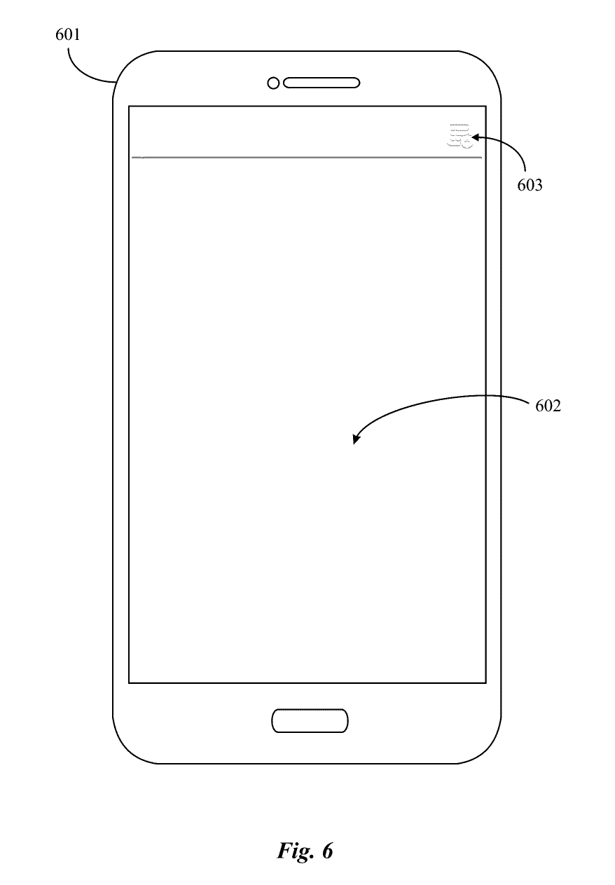

FIGS. 6-9 are screenshots of a user interface illustrating a shopping list interface according to an embodiment of the present invention. Referring to FIG. 6, the shopping list interface is shown on a mobile device 601. The shopping list interface allows a user to add items to a shopping list. To add items to the shopping list a user may click on add icon 603, which is also displayed in the middle area of the user interface 602.

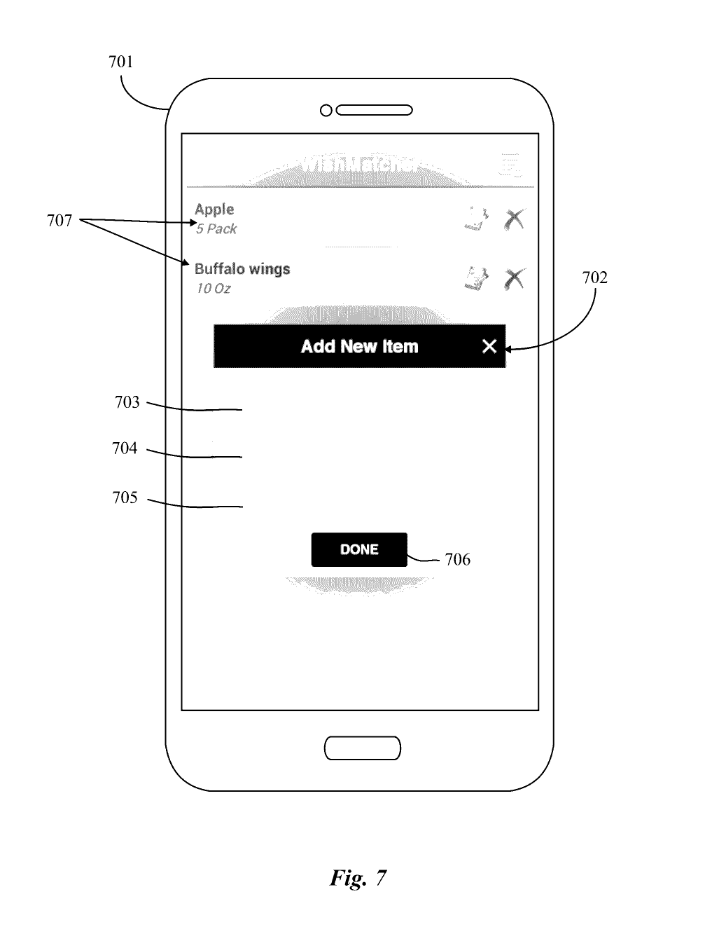

Referring to FIG. 7, the shopping list interface is shown on a mobile device 701. Once a user selects the add icon 603 (FIG. 6), a query to add a new item 702 is prompted. This allows the user to enter the product name of the item 703, unit of measure 704, and quantity 705. For example, a user may enter a product name of ‘Apples’, a unit of measure of ‘pounds (lbs)’, and a quantity of ‘5’. After completion, the user may select done 706 to add the item to the list. This entry would correspond to five pounds of apples being added to the shopping list. The user would follow this procedure for any desired items to be generated on the shopping list. There is no limit to the amount of items which can be added, a user simply needs to repeat the process for each additional item. Each item added will be displayed in a list 707 on the user interface.

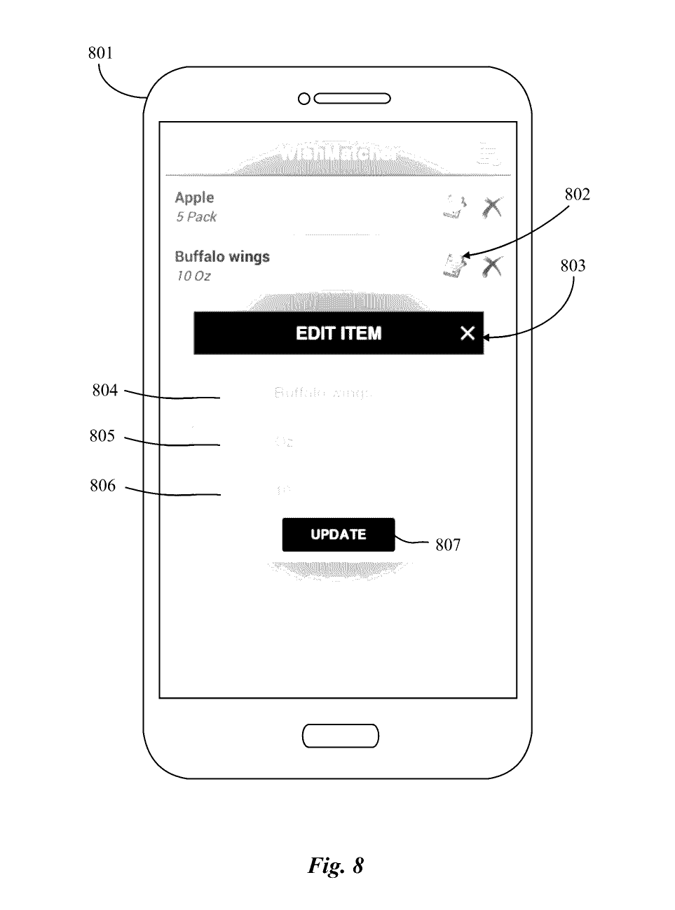

Now referring to FIG. 8, the shopping list interface is shown on a mobile device 801. A user may edit an item in the shopping list by selecting edit icon 802. Once the edit icon is selected, a query to edit the selected item 803 is prompted. This allows the user to edit the product name of the item 804, unit of measure 805, and quantity 806. After completion, the user may select update 807 to add the edited item to the list.

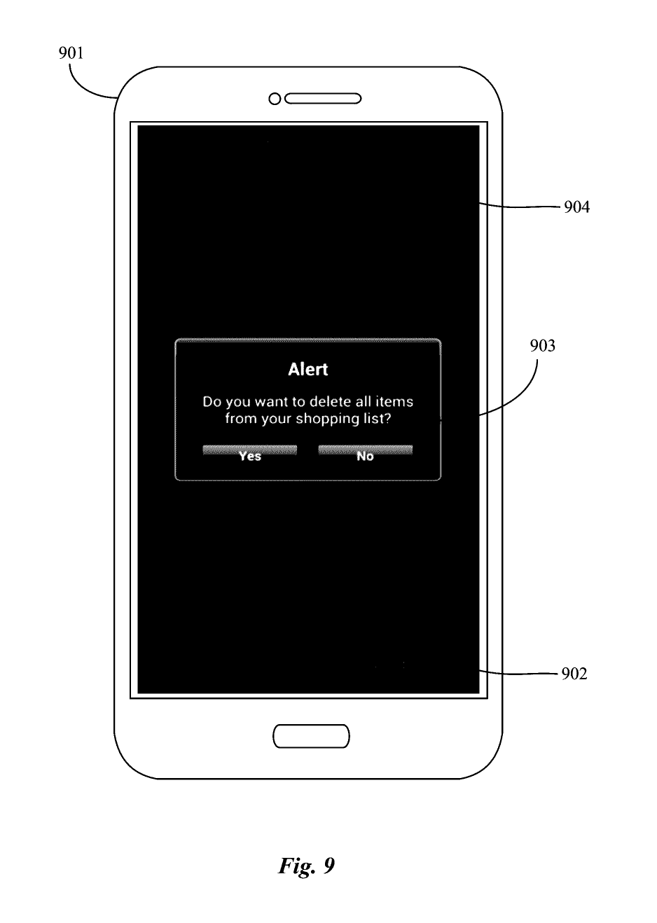

Referring to FIG. 9, the shopping list interface is shown on a mobile device 901. Items in the shopping list may be stored in a local database or deleted. If deletion is desired, a user may select clear 902, which prompts alert window 903 allowing the user to execute the deletion of the shopping list or cancel the deletion process. Likewise, if deletion of a single item is desired, the user may select the delete icon 904.

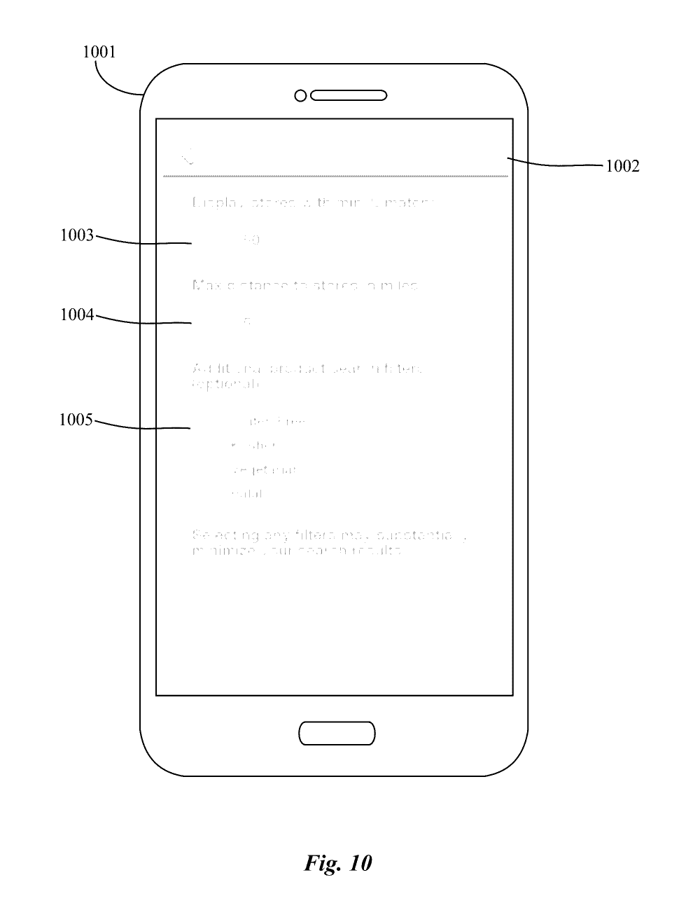

FIG. 10 is a screenshot of a user interface illustrating a plurality of search preferences 1002 according to an embodiment of the present invention. The plurality of search preferences is illustrated on mobile device 1001 is prompted when a user selects search settings 405 (FIG. 4) on the application menu 403 (FIG. 4). The plurality of search preferences comprises a percentage match filter 1003, a distance filter 1004, and an additional product search filters 1005. The inventive embodiment depicted in FIG. 10 allows a user to modify the plurality of search preferences, which will adjust the aggregated search results of the directory list of stores. The modification and adjustment of the plurality of search preferences and corresponding aggregated search results of store directories of this embodiment will be described in greater detail below.

Still referring to FIG. 10, the percentage match filter allows a user to set the minimum percentage match, which corresponds to the percentage match of inventory in a store in relation to the user's shopping list. In an example embodiment, a user may enter a percentage match filter value of 50%. This value would limit the aggregated search results of the directory list of stores to only include stores with an inventory match percentage greater or equal to 50%. Put simply, if a store only had an inventory match of 40% in relation to the user's shopping list, the store would not be displayed in the directory list of stores. Consequently, a high percentage match filter value will limit the number of stores displayed in the directory and a low percentage match filter value will increase the number of stores displayed in the directory list of stores.

Yet still referring to FIG. 10, the distance filter allows a user to enter a value in miles which limits the search radius of the aggregated search results of the directory list of stores to the entered value in relation to the user's location. In an example embodiment, a user may enter a distance filter value of 5 miles. This value would limit the aggregated search results of the directory list of stores to only include stores within a 5 mile radius of the user's location. The user location will be identified by a global positioning system (GPS) hardware system located in the mobile device. Therefore, a larger distance filter value will increase the number of stores displayed in the directory list of stores. The additional product search filters allow a user to make a selection of a number of optional search filters including but not limited to gluten free, kosher, organic, and Halal. Multiple additional product search filters may be selected at once. Likewise, no additional product search filters are required for selection. In an example embodiment, a user may select the gluten free product search filter. This selection would limit the aggregated search results of the directory list of stores to only include stores that have gluten free products matching the user's shopping list. Accordingly, if numerous additional product search filters are selected the number of stores displayed in the directory list of stores will decrease. The plurality of search preferences will be saved as default settings for any future searches, until further modification. The inventive plurality of search preferences element of the embodiment described above, gives a user total control of their shopping expectations, saving time and making their shopping experience more efficient.

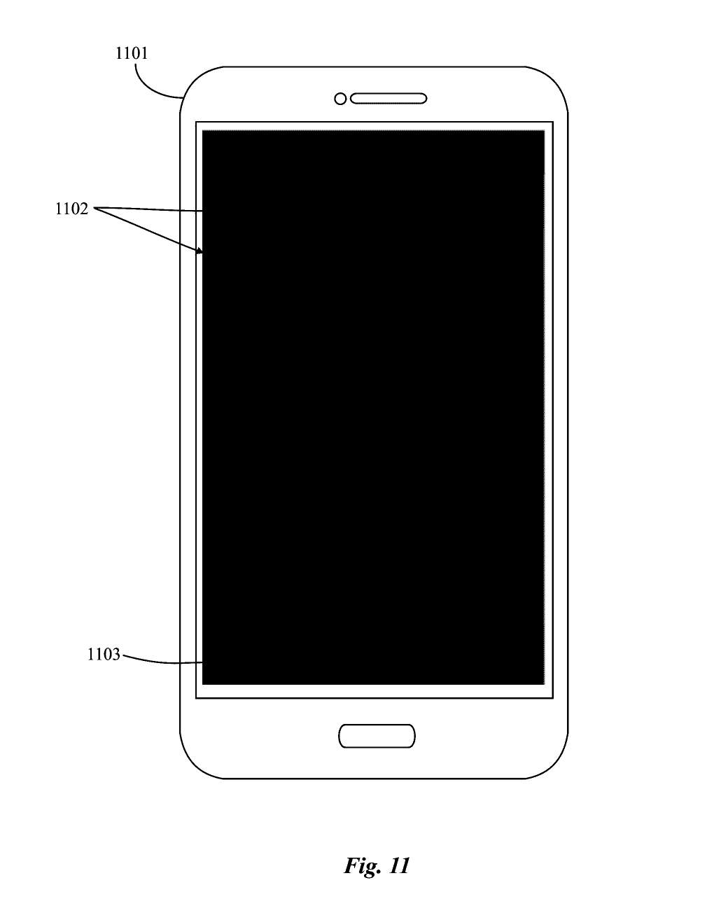

FIG. 11 is a screenshot of a user interface illustrating a shopping list interface according to an embodiment of the present invention. The shopping list interface is shown on a mobile device 1101. In this example, the user has a shopping list comprising items 1102. When the user is finished generated the shopping list, the user may select done 1103. This will start the processing allowing the mobile application software to compile a directory of stores that have inventories which match the items in the shopping list. The directory will be aggregated based on the user's search preferences (FIG. 10). This will be discussed in greater detail below.

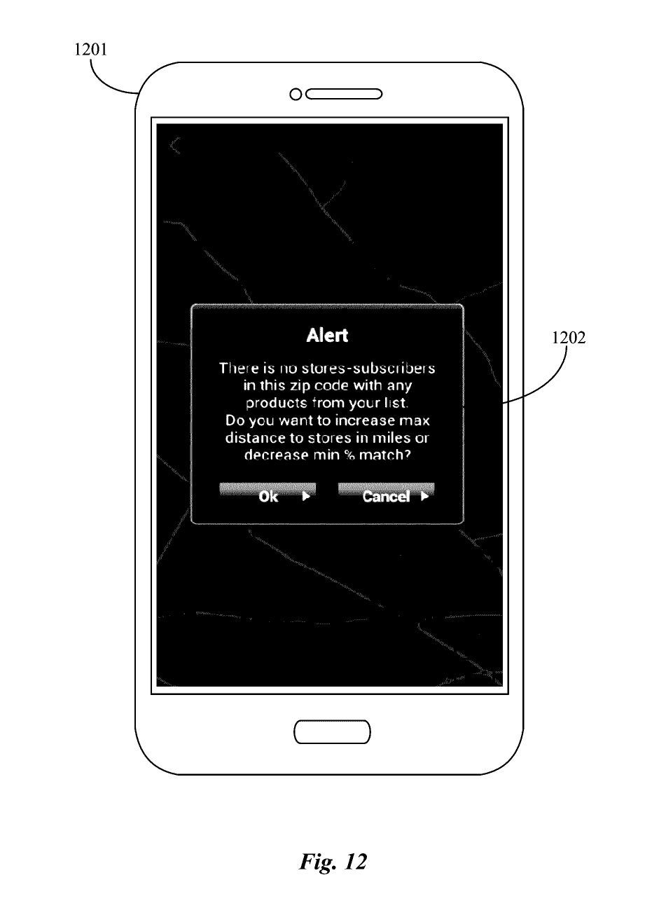

FIGS. 12-16 are screenshots of a user interface illustrating a directory interface according to an embodiment of the present invention. Referring to FIG. 12, the directory interface is shown on a mobile device 1201. In this embodiment, alert window 1202 will appear if the aggregated directory list of stores fails to meet the minimum values of the plurality of search preferences set by user. In this example, the user has the option of returning to change any one of the plurality of search preferences to adjust the aggregated search results of the directory list of stores. These options include increasing the distance filter, lowering the match percentage filter, or deselected additional product search filters.

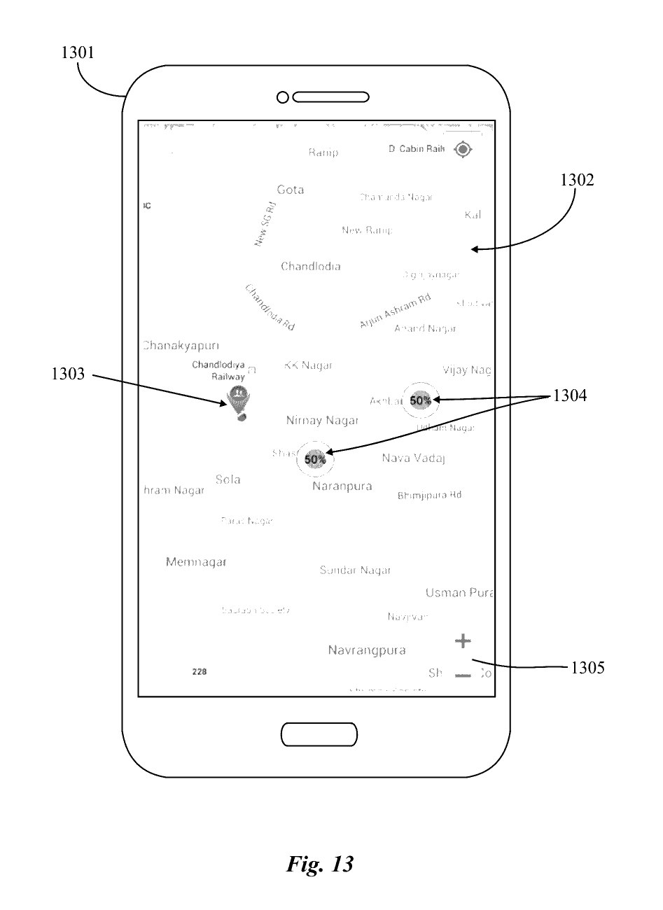

Referring to FIG. 13, the directory interface is shown on a mobile device 1301. In this embodiment, a map 1302 comprises a user location icon 1303 displaying the approximate location of the user. The map further includes the aggregated directory list of stores which is represented by store icons 1304. The store icons display the percentage match of the store inventory corresponding to the user's shopping list. Only stores above the threshold of the match percentage query of the plurality of search preferences will be shown. If more information about a store in the aggregated directory list of stores is desired, a user can click on the store icon. This will be discussed in greater detail below. The user may utilize a zooming tool 1305, to set the zoom level of the map as known in the art.

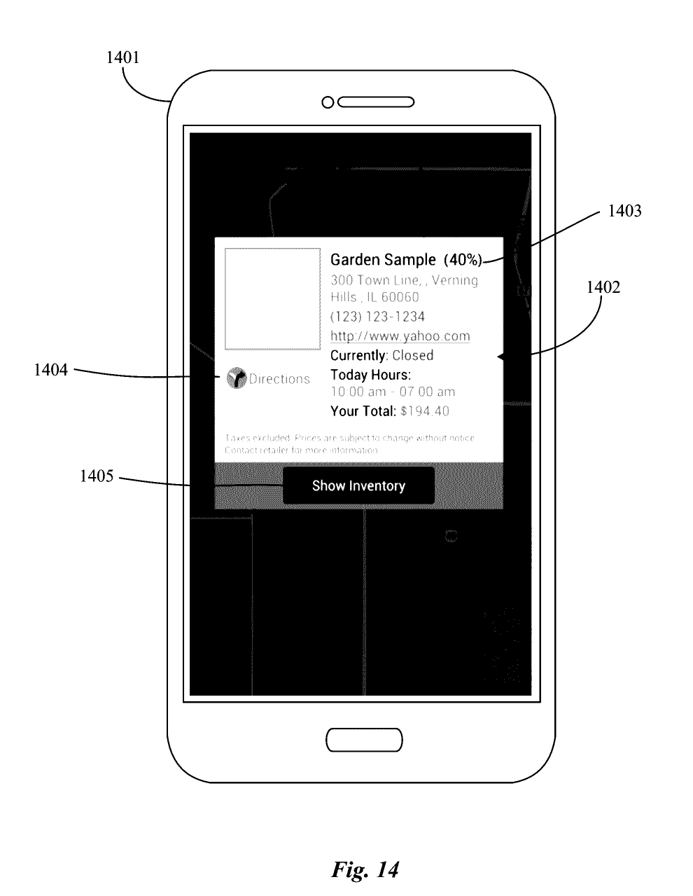

Now referring to FIG. 14, the directory interface is shown on a mobile device 1401. In this example, a user has selected a store icon 1304 (FIG. 13) which prompted a directory listing 1402 of the corresponding store in the aggregated directory list of stores. The directory listing comprises useful information, including but not limited to store name, address, phone number, web address, hours of operation for the current day, and if the store is currently open or closed. The directory listing further includes the inventory match percentage value 1403 and the approximate total of the user's shopping list excluding tax. The inventory match percentage value corresponds to the percentage match of inventory in a store in relation to the user's shopping list. The user also has the opportunity to access driving directions 1404. The user may also view the store inventory by selecting show inventory 1405. This will show the user all the store items that match the generated shopping list.

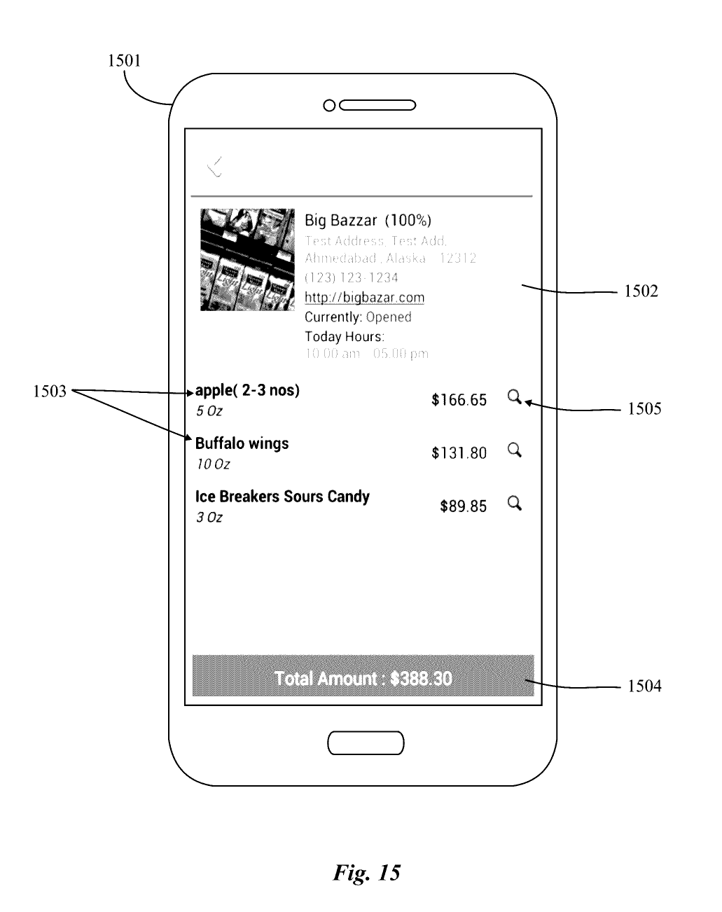

Referring to FIG. 15, the directory interface is shown on a mobile device 1501. In the illustrated embodiment, the user has selected show inventory 1405 (FIG. 14) prompting the screenshot illustrated. The store inventory comprises directory information 1502 and an inventory list 1503. The directory information includes all the information seen in the directory listing (FIG. 14). The inventory list displays a list of store items 1503 that match the user's generated shopping list. The list of store items comprise a plurality of information, including but not limited to product name, product unit of measure, product quantity, and product price. The story inventory further comprises a total price amount 1504, representing an approximate cost for all the list of store items combined. In this embodiment, a user may select a matching icon 1505, which will display a list of partially matching store products to each specific store item on the inventory list.

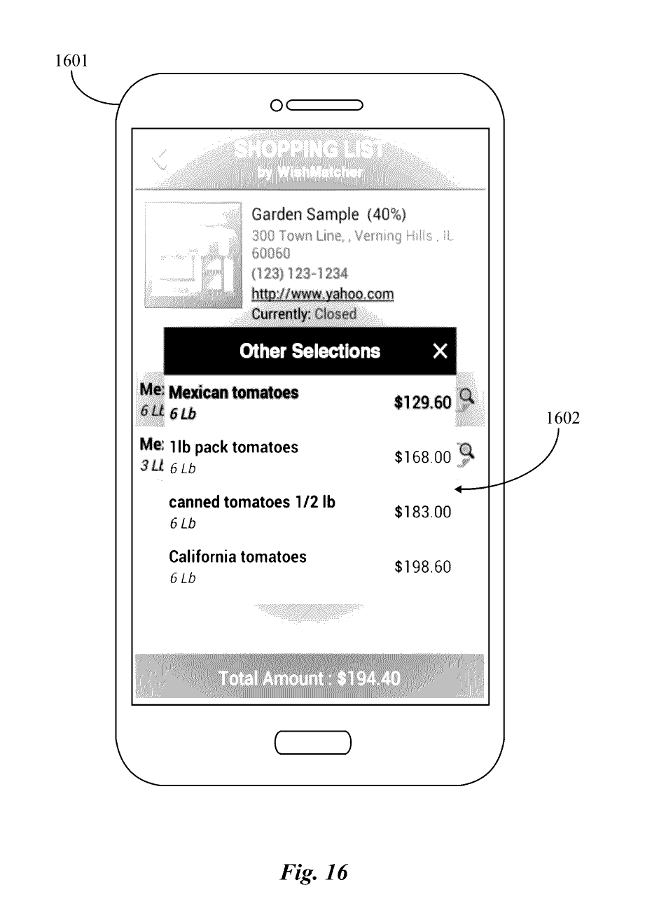

Now referring to FIG. 16, the directory interface is shown on a mobile device 1601. In the illustrated embodiment, the user has selected the matching icon 1505 (FIG. 15) prompting a list of other selections 1602 illustrated in the example screenshot. The list of other selections include a list of partially matching stores products to each specific store item on the inventory list as described above. For example, if the specific item generated to the shopping list is “Mexican tomatoes”, similar items will be displayed that are in stock in that specific store, such as “California tomatoes, or “canned tomatoes”. In this embodiment, the user can make an alternative item selection by selecting any of the displayed partially matching store products.

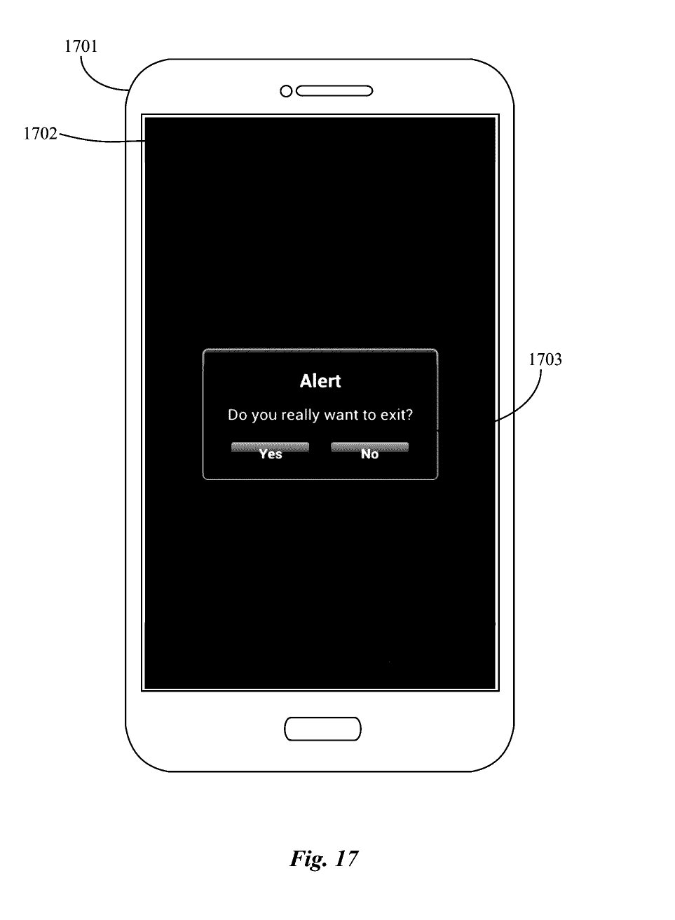

FIG. 17 is a screenshot of a user interface illustrating a shopping list interface according to an embodiment of the present invention. The shopping list interface is shown on a mobile device 1701. Once a user is finished operating the mobile application software, the user may select exit 406 (FIG. 4) from the application menu 1702. Once selected, an alert window 1703 will be prompted asking the user if they indeed want to exit the application. If confirmed, upon exiting the application all the items generated in the user shopping list will be stored in the system.

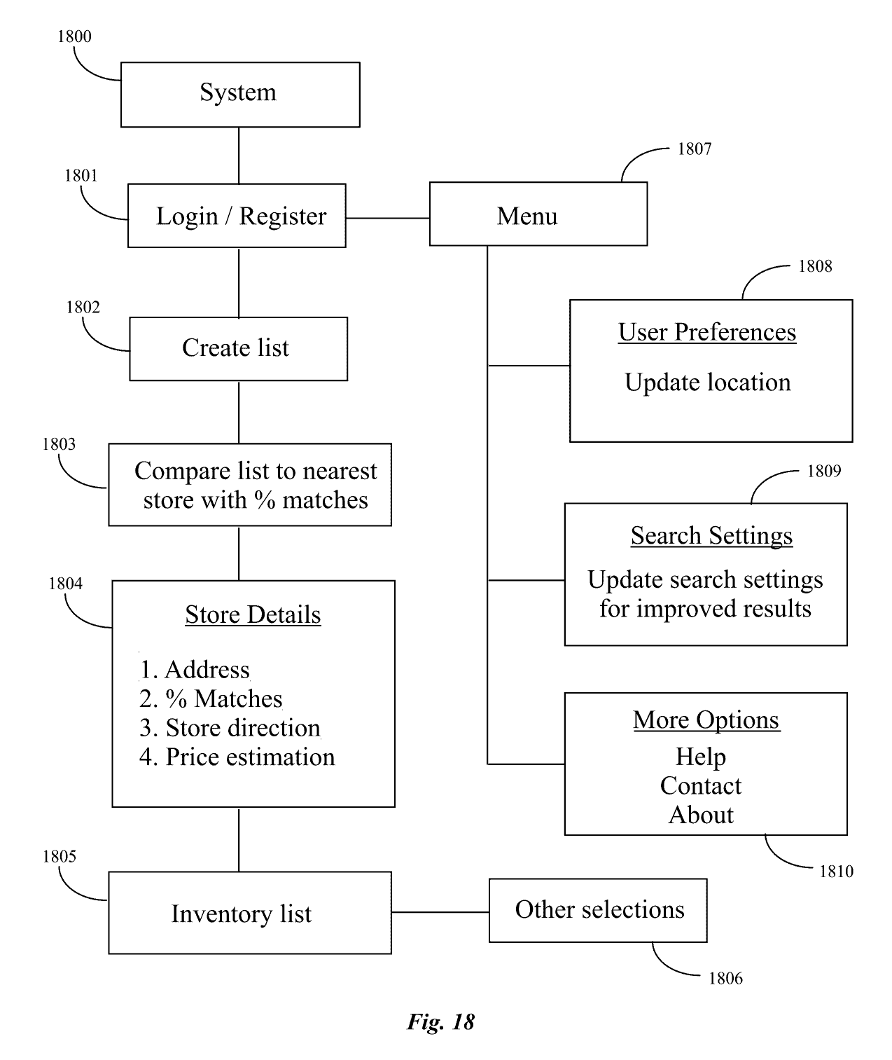

FIG. 18 is a block diagram illustrating the mobile application software of FIG. 1 according to an embodiment of the present invention. When a user accesses the mobile application software and system 1800, the user is prompted to login 1801 with their unique account credentials. If the user does not have an account previously established, they may register for an account. Once the user is logged into the system, the user may create a personalized shopping list 1802. The created list may include a plurality of product or store items in various quantities. In step 1803, the user may compare the personalized shopping list with a directory list of stores. The directory list of stores includes the percentage of inventory items that match the personalized shopping list. In step 1804, a user may access individual store details which include a store address, a percentage value of inventory items that match the personalized shopping list, directions to that specific store, and the price estimation for personalized shopping list that is matched to the inventory of the store. In step 1805, the user may display an inventory list for a specific store in the directory list of stores. The inventory list will list all the items that match the personalized shopping list. In step 1806, a user may select from a list of option selections. The list of other selections include a list of similar or partially matching stores items to each specific store item on the inventory list. The user may choose to select and add any of the partially matching store items to the personalized shopping list.

Still referring to FIG. 18, once the user is logged into the system, the user has access to a user menu 1807. From the user menu, the user may access user preferences 1808 to update their location. The user also has access to search settings 1809, which feature a plurality of search queries to improve the generated list of store directory results. The various search queries will provide more specific results to tailor a user's preferences including percentage match minimums, distance requirements, and dietary restrictions. The user has further access to more options 1810, which include help using the system, the ability to contract administrators, and information about the system.

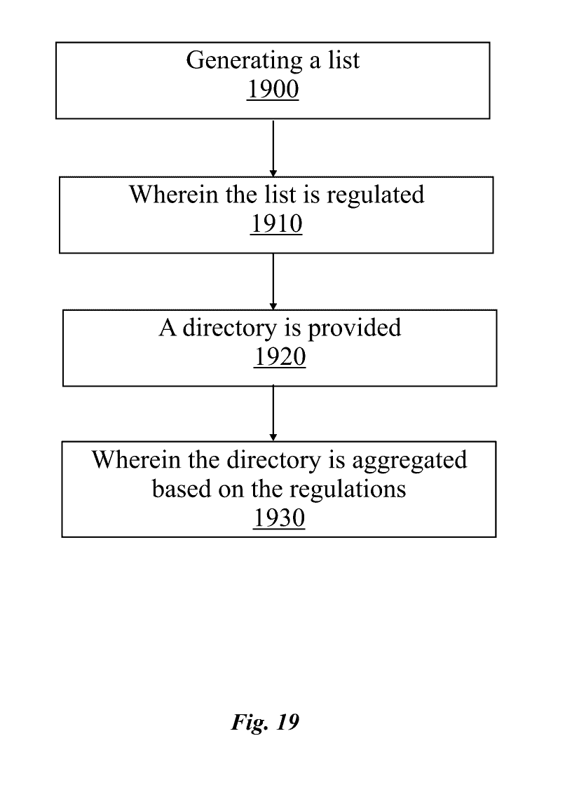

FIG. 19 illustrates a flowchart for a mobile application according to an embodiment of the present invention. In step 1900, a list is generated, for example a user generated list of shopping items. In step 1910, the list is regulated, for example, by a series of search parameters and preferences. In step 1920, a directory is provided. In step 1930, the directory is aggregated based on the regulations.

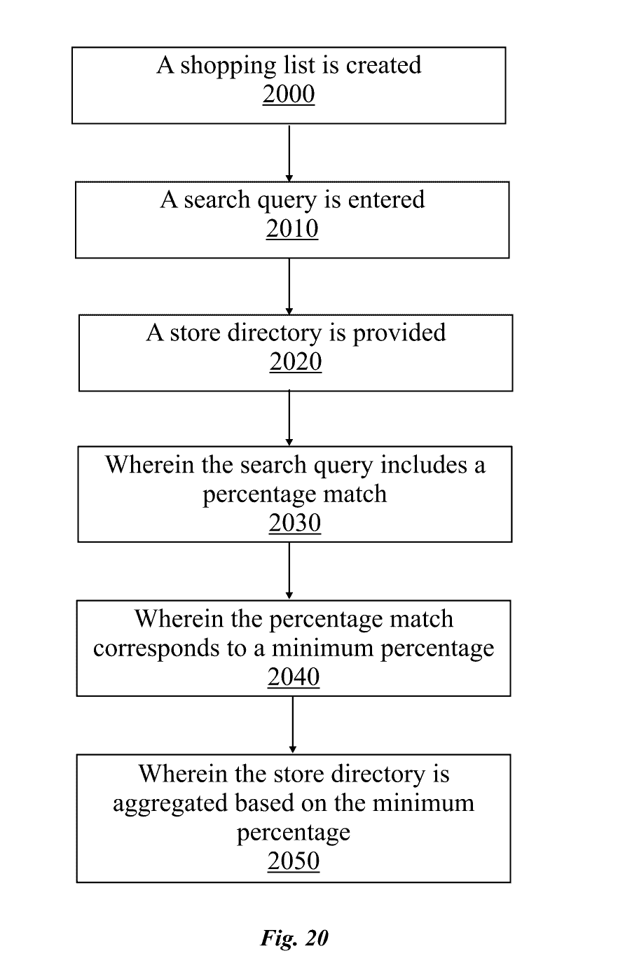

FIG. 20 illustrates a flowchart for a mobile application according to an embodiment of the present invention. In step 2000, a shopping list is created. In step 2010, a search query is entered. In step 2020, a store directory is provided. In step 2030, the search query includes a percentage match. In step 2040, the percentage match corresponds to a minimum percentage. In step 2050, the store directory is aggregated based on the minimum percentage.

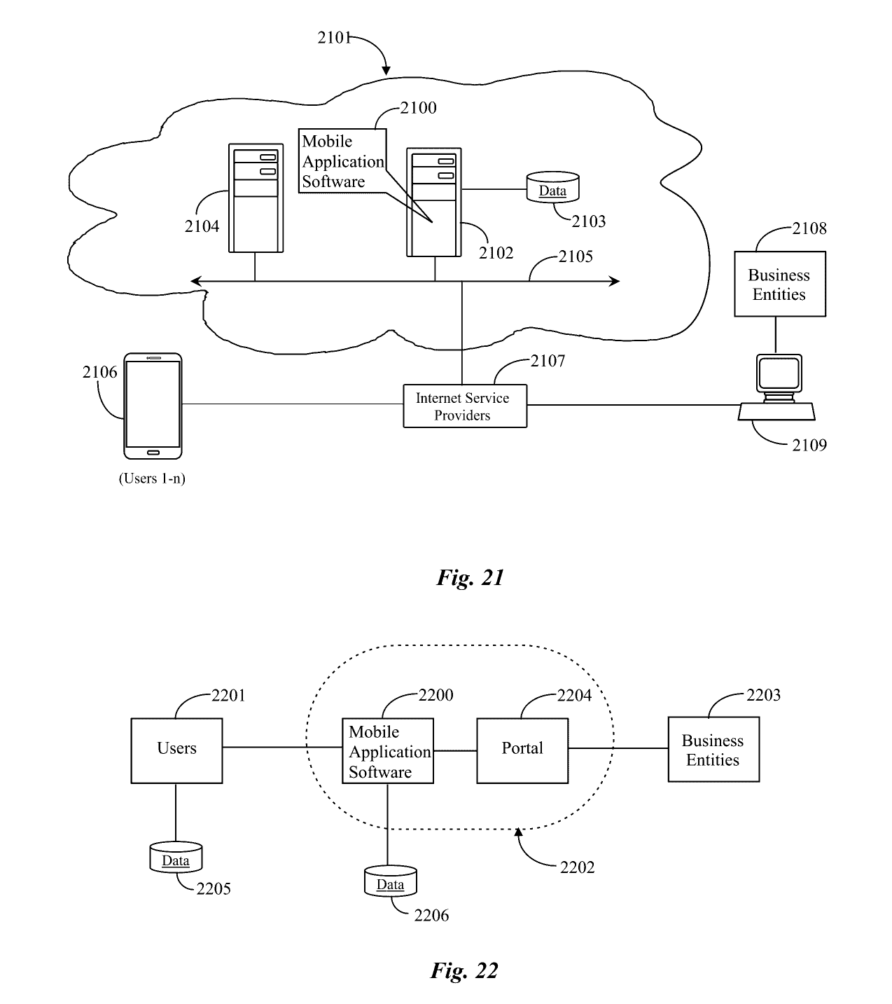

FIG. 21 is an architectural diagram of an Internet mobile computer network system according to an embodiment of the present invention. The Internet-connected system comprises one or more Internet-connected servers 2102, executing mobile application software 2100 from non-transitory media. Server 2102 is connected to a data repository 2103, which may be any sort of data storage known in the art. The system further comprises a third party Internet-connected server 2104 connected to Internet backbone 2105. Although one third party Internet-connected server 2104 is shown, it is understood that potentially millions of other similar servers are connected to the Internet via Internet backbone. A number of users (1-n) 2106 on a mobile device are connected to the Internet-connected server via an Internet service provider (ISP) 2107, allowing users 2106 to access the mobile application software. The system further comprises business entities 2108 using computers 2109 to access the mobile application software via the Internet service provider and Internet backbone. The business entities may be any number of businesses including but not limited to grocery stores, retail stores, and supermarkets.

FIG. 22 is an architectural diagram of a mobile application software 2200 network system according to an embodiment of the present invention. The system comprises users 2201 in communication with the mobile application software over network 2202. Users 2201, represents any number of users on a mobile computer with local storage data 2205. The system further comprises business entities 2203 in communication with portal 2204 and mobile application software 2202 over the network. The portal allows business entities to upload data to the mobile application software which is stored in data source 2206. This data can be accessed by the users over the network. Specifically, data representing inventory lists of each business entity. This data is used when users generate personalized shopping lists and store directories as described herein.

It will be apparent to one with skill in the art, that the embodiments described above are specific examples of a single broader invention which may have greater scope than any of the singular descriptions taught. There may be many alterations made in the descriptions without departing from the spirit and scope of the present invention.

What is claimed is:

1. A method comprising steps:
(a) a user at a geographical location using a mobile device logs in to a mobile computer network system;
(b) the user generates a list of items;
(c) the user enters a plurality of search preferences, wherein the plurality of search preferences consists of a percentage match filter value, a distance filter value, and a selection of optional special preferences filters; and
(d) a first directory list is provided as a result of the plurality of search preferences, wherein the directory list comprises a first list of stores.

2. The method of claim 1 wherein in step (b), the list of items is a shopping list comprising a plurality of edible items.

3. The method of claim 1 wherein in step (b), the list of items is added to a previously saved list of items creating a new single list of items, the new single list of items is a shopping list comprising a plurality of edible items, the plurality of edible items can be added or deleted from the shopping list, wherein the user is limited to one shopping list.

4. The method of claim 1, wherein in step (c), the percentage match filter value allows the user to set a minimum percentage match value such that:
the first list of stores is limited to a filtered list of stores having an inventory list comprising a percentage value of items that are equal to the list of items generated by the user, wherein the percentage value of items is greater or equal to the minimum percentage match value.

5. The method of claim 1, wherein in step (c), the distance filter value allows the user to set a maximum distance value such that:
the first list of stores is limited to a filtered list of stores having a proximity, wherein the proximity is at a distance that is less than or equal to that maximum distance value from the geographical location of the user.

6. The method of claim 1, wherein in step (c), the selection of optional special preferences filters comprises a plurality of filters essentially consisting of a gluten free filter, a kosher filter, an organic filter, and a halal filter.

7. The method of claim 6, wherein in step (c), the selection of optional special preferences filters allows the user to select any filter in the plurality of filters such that:
the first list of stores is limited to a filtered list of stores having an inventory list comprising a list of items that match any of the selected filters of the plurality of filters in the selection of optional special preferences filters.

8. The method of claim 1 wherein in step (d), the first list of stores is represented on a graphical map.

9. The method of claim 1 wherein in step (d), each store included in the first list of stores comprises an inventory list.

10. The method of claim 1, further providing a step wherein the plurality of search preferences can be modified, wherein the modifications correlate to a second directory list provided, the second directory list having a second list of stores.

11. The method of claim 10, wherein the second list of stores is represented on a graphical map, and each store included in the second list of stores comprises an inventory list.

12. A system comprising:
an Internet-connected computerized appliance having a processor and coupled to a data repository, the processor executing software from a non-transitory medium, the software providing an interactive interface to a mobile application system, the system enabling a user to:
create an account;
log on and enter a location;
create a shopping list of items;
set a plurality of search preferences;
set user preferences;
access a directory list of local stores, each store having an inventory list of items;
access an address and driving directions to each store;
compare the shopping list to the inventory list of items;
visualize the comparison of the shopping list of items to the inventory list of items as a percentage value defining the number of matching item in the shopping list of items to the inventory list of items; and
define a minimum percentage value limiting the directory list of local stores to only stores with the percentage value greater or equal to the minimum percentage value.

13. The system of claim 12, wherein the search preferences comprises a plurality of filters essentially consisting of a gluten free filter, a kosher filter, an organic filter, and a halal filter.
